(19) United States
(12) Patent Application Publication
(10) Pub. No.: US 2008/0109211 A1
(43) Pub. Date: May 8, 2008

(54) Game of defending statements with persuasive arguments

(76) Inventor: John Perry, Highgate Center, VT (US)

Correspondence Address: John J. Welch, Jr., Esq., 8 E. Center Street, Rutland, VT, 05701, US

(21) Appl. No.: 11/593,536

(22) Filed: Nov. 7, 2006

(51) Int. Cl. G06F 17/27

(52) U.S. Cl. 704/9

(57) ABSTRACT

A game of defending statements with persuasive arguments consisting of a tossing bag, a “frequency” block, two equivalent “equation” blocks; three “verb” blocks and ten “noun” blocks, a number of which are shook inside the bag, then tossed onto a table top by a so-called author who then must form and then refine a statement from the words and symbols on the face up topsides of the tossed blocks, then contrive an argument based upon the statement meant to result in the articulation of a discernible concept, challengeable however by non-author players of the game; then requiring a defense of such an argument, resulting in an awarding of playing points or not depending upon the assessment by a majority of such non-author players as to the merits of such an argument or defense whereupon one; once an author-player; then becomes a challenger-player as another player, formerly a challenger then becomes an author.

### CROSS REFERENCES TO PRIOR OR PARENT APPLICATIONS

There are no prior or parent applications that related to the herein described invention.

### FEDERALLY SPONSORED RESEARCH AND DEVELOPMENT

There is no federally sponsored research and development relating to the herein described invention.

### BACKGROUND OF THE INVENTION

1. Field of the Invention

The instant invention is a multi-player game involving a combining of words into statements amenable to defense by argument.

2. Related Art

The art depicted in and within the Art Informational Statement submitted herewith resembles but clearly does not anticipate the instant invention.

### A SUMMARY OF THE INVENTION

1. A Brief Description of the Invention

The instant invention is a game playable by a plurality of persons, for instance, up to ten persons. It consists of a tossing bag containing a plurality of blocks. There are also cards to be utilized in conjunction with playing the game that are designated as author, opponent and challenge cards as well as ballot cards. There is also a timer device to be utilized in conjunction therewith as well. There is contemplated to be a notepad and pencil for keeping score as well. There are 16 blocks in all. The blocks consist of 2 equivalent equation blocks, 3 non-equivalent verb blocks, 10 non-equivalent noun blocks and one frequency block. There are 40 ballot cards. 10 of these are so-called “Yes” cards, 10 are so-called “No” cards. There are 10 designated Author cards and 10 designated Opponent cards. There is a basic game format. There is an intermediate game format and an advanced game format as well. The frequency block with an adverb depicted on each facet thereof, timer and challenge cards are intended for use within the non-basic game formats.

The Author and Opponent cards are reserved for use only when playing within the advanced game format.

The basic game format consists of a rolling of the blocks by a player. Each facet of each block has a noun written on it for the noun blocks save for a so-called “wild” facet on one of these; a verb on each facet for the verb blocks save for a so-called “wild” facet on one of these and symbols for “equals”, “doesn't equal”, “plus”, “minus”, “greater or less than” and one blank so-called “wild” facet as respects the facets respectively of the equation blocks. A player designated as an author composes a statement using some or all of the words and symbols that are found face up on the rolled blocks. That player has a certain amount of time upon completion of a roll to compose such a statement literally followed by an interpretation or refining of it, then followed by a subsequent period of time within which to defend the interpretation with elaborative argument. The argument is then accepted or may be challenged by any of the other players. If challenged, the author must defend his or her argument in time limited discussion. If an argument as so defended is accepted by the other players, the arguing player, to wit, the author is then awarded points based upon the number of blocks resorted to for purposes of initially deriving the statement. The blocks are then bagged to then be rolled by the next player, now, an author, and so on through typically four rounds of play, if, for instance, it is predetermined that the game will be played in only its basic format. The intermediate game format follows the basic one except however the intermediate one provides for the issuance of challenge cards to each player serving to allow each player one challenge only per game. This format also provides for use of the frequency block as well as a debate protocol requiring the use of a timer device operated by a debate moderator selected in advance by the players from among them. The advanced format features all of the above but with the use of the Opponent and Author cards and provides for the accrual of points to a challenger.

Customarily, the game will be played with a pre-determined number of rounds in the basic format, then a predetermined number of rounds in the intermediate format and a predetermined number of rounds in the advanced format.

2. Objects of the Invention

The invention serves to provide players with a vibrantly interactive means for engaging in intellectually stimulating verbal undertakings. As such, it unquestionably constitutes what would be an extremely useful educational tool for purposes of serving any need to foster one's development of a penchant for not only creative thinking but also then creatively communicating as well. Separate and apart however from what would be its advantages as an educational tool, is the fact that the invention also affords game players with an opportunity to participate in a truly enjoyable, uniquely relaxing group experience.

### A DESCRIPTION OF THE DRAWINGS

FIG. 1 is a plan view of the tossing bag component of the instant invention.

FIG. 2 is a perspective view of the frequency block component of the instant invention.

FIG. 3 depicts in an unfolded plan view the words on the various facets of the frequency block.

FIG. 4 is a perspective view of one of the two equivalent equation block components of the instant invention.

FIG. 5 depicts in an unfolded plan view, the symbols on the various facets of each of the equation blocks.

FIG. 6 is a perspective view of a first one of the three non-equivalent verb block components of the instant invention.

FIG. 7 depicts the words in an unfolded plan view on the various facets of the verb block shown in FIG. 6.

FIG. 8 is a perspective view of a second one of the three non-equivalent verb block components of the instant invention.

FIG. 9 depicts in an unfolded plan view, the words on the various facets of the verb block shown in FIG. 8.

FIG. 10 depicts in an unfolded plan view the words on the various facets of the third verb block component of the instant invention.

FIG. 11 is a perspective view of a first one of the ten non-equivalent noun blocks of the instant invention.

FIG. 12 depicts in an unfolded plan view, the words shown on the various facets of the noun block shown in FIG. 11.

FIG. 13 depicts in an unfolded plan view, the words on the various facets of a second noun block of the instant invention.

FIG. 14 depicts in an unfolded plan view, the words on the various facets of a third noun block of the instant invention.

FIG. 15 depicts in an unfolded plan view, the words on the various facets of a fourth noun block of the instant invention.

FIG. 16 depicts in an unfolded plan view, the words on the various facets of a fifth noun block of the instant invention.

FIG. 17 depicts in an unfolded plan view, the words on the various facets of a sixth noun block of the instant invention.

FIG. 18 depicts in an unfolded plan view, the words on the various facets of a seventh noun block of the instant invention.

FIG. 19 depicts in an unfolded plan view, the words on the various facets of an eighth noun block of the instant invention.

FIG. 20 depicts in an unfolded plan view, the words on the various facets of a ninth noun block of the instant invention.

FIG. 21 depicts in an unfolded plan view, the words on the various facets of a tenth noun block of the instant invention.

FIG. 22 is a plan view of the top side of one of a plurality of equivalent challenge card components of the instant invention.

FIG. 23 is a plan view of the bottom side of one of a plurality of equivalent challenge card components of the instant invention.

FIG. 24 is a plan view of the top side of one of a plurality of equivalent negative ballot card components of the instant invention.

FIG. 25 is a plan view of the bottom side of one of a plurality of equivalent negative ballot card components of the instant invention.

FIG. 26 is a plan view of the top side of one of a plurality of equivalent affirmative ballot card components of the instant invention.

FIG. 27 is a plan view of the bottom side of one of a plurality of equivalent affirmative ballot card components of the instant invention.

FIG. 28 is a plan view of the top side of one of a plurality of equivalent Opponent card components of the instant invention.

FIG. 29 is a plan view of the bottom side of a plurality of equivalent Opponent card components of the instant invention.

FIG. 30 is a plan view of the top side of a plurality of equivalent Author card components of the instant invention.

FIG. 31 is a plan view of the bottom side of a plurality of equivalent Author card components of the instant invention.

FIG. 32 is a perspective view of a stopwatch component of the instant invention.

FIG. 33 illustrates in perspective view some just tossed block components with up faces depicting words to be utilized in forming a statement.

### A DESCRIPTION OF THE PREFERRED EMBODIMENT

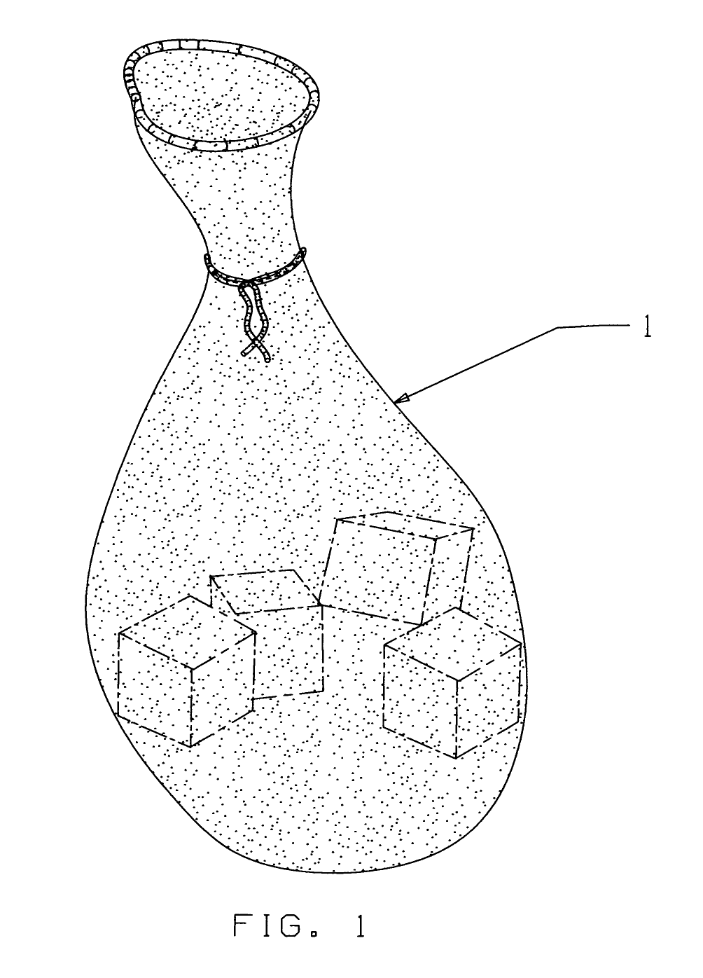

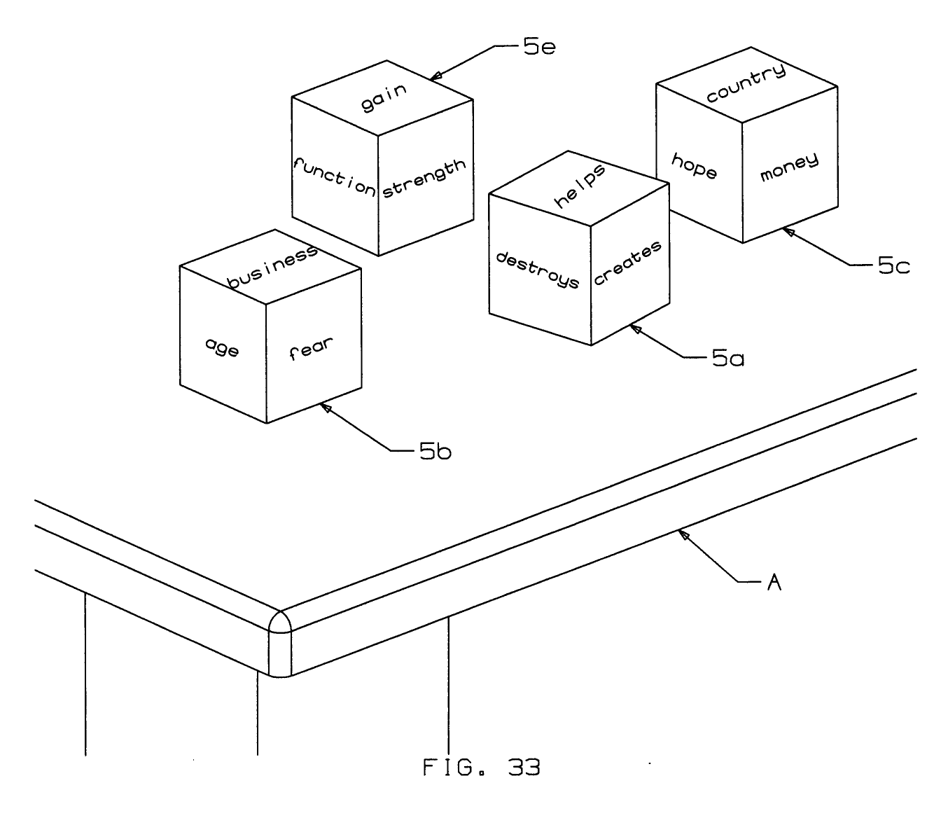

Anywhere from two to ten players may play the game each individually. An even number of players is desireable for purposes of playing within the basic or intermediate game formats. An odd number is suggested as respects the advanced format. The game is one involving initially the composition of a statement consisting at least three of the words depicted on the face-up facets of blocks rolled onto a floor or a table after having been shaken within and then spilled out of a tossing bag component 1 as depicted in FIG. 1. Such composition is undertaken by the persons having just shaken tossing bag component 1 filled with blocks. This person is designated as an author. Blocks having been shaken and then spilled out of a bag 1 and landing on, for example, a tabletop A as illustrated in 33 are then utilized by the author to compose a statement. The statement is then refined by the author. Refining connotes the utilization of no less than three or more of the words on the face-up facets of, for example, verb block 4a and noun blocks 5b, 5c and 5e as can be seen after tossing in FIG. 33 to formulate a proposition therefrom in the form of a complete sentence such as, for instance, “Business gain helps a country”. Resort to utilization of pluralization of the words to be relied upon along with prepositions as well as definite or indefinite articles is permitted in respect of such sentence formulation. A supportive argument in justification of the merits of the refined statement is then proffered by the author. An illustration of what might constitute such an argument within the context of the foregoing stated example might be, for instance, business gains being a boon to the economy of a country, invariably helps that country to prosper. If the argument is accepted by a majority of the other players, the author is awarded points based upon the number of blocks utilized by the author to compose the initial statement. If the argument, on the other hand, is challenged, then the argument is defended by the author. An illustration of such a defense might be, in this instance, the recitation of the assertion that as business profits go up, money is spent by the owners to provide economic impetus to others who would not otherwise be so enabled to prosper. If the defense is then accepted by a majority of the other players, the author gets the points awardable with scoring as will be noted below. If the defense is not accepted by a majority of the other players, then the author gets no points. The tossing bag 1 is then again filled with blocks and a next player in the group becomes the author deigned to proceed as did the previous player in an effort to be ultimately awarded points. Each player; in an effort to secure points based upon a tossing of blocks, a composition of a statement therefrom, a refining thereof, and an argument in support of the same and perhaps yet more argument in defense of the same; is typically given two minutes to compose such a statement and, then typically more three minutes to refine and it and then derive a supportive, and, if need be, further defensive argument hopefully amenable to ultimate acceptance by a majority of the other opposing players.

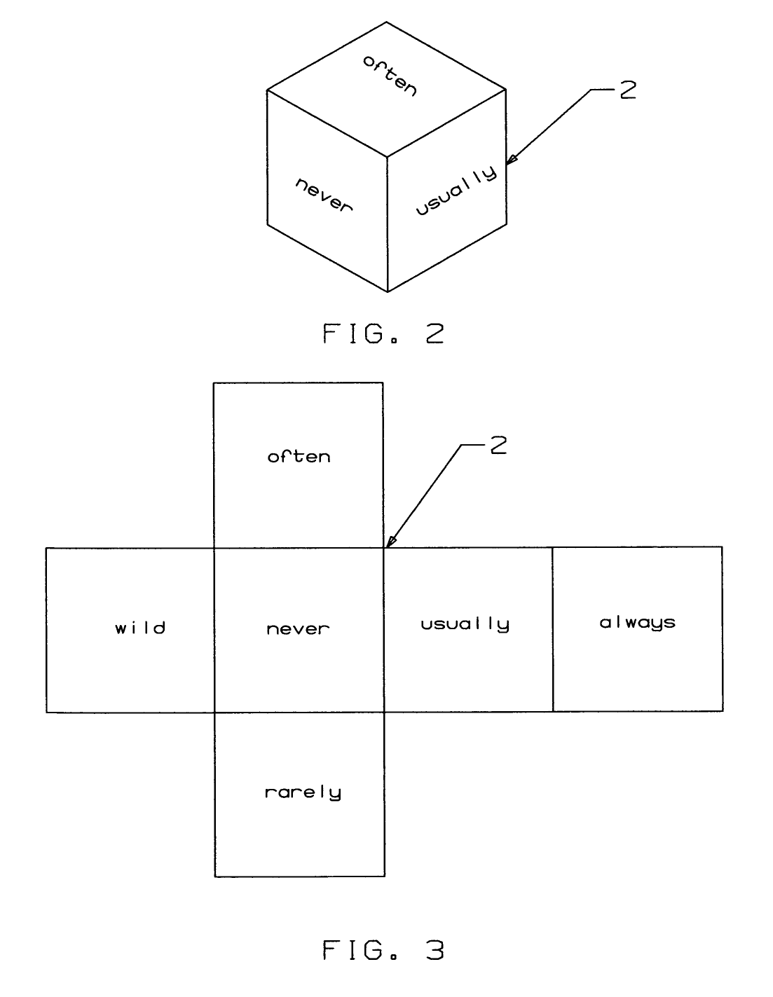

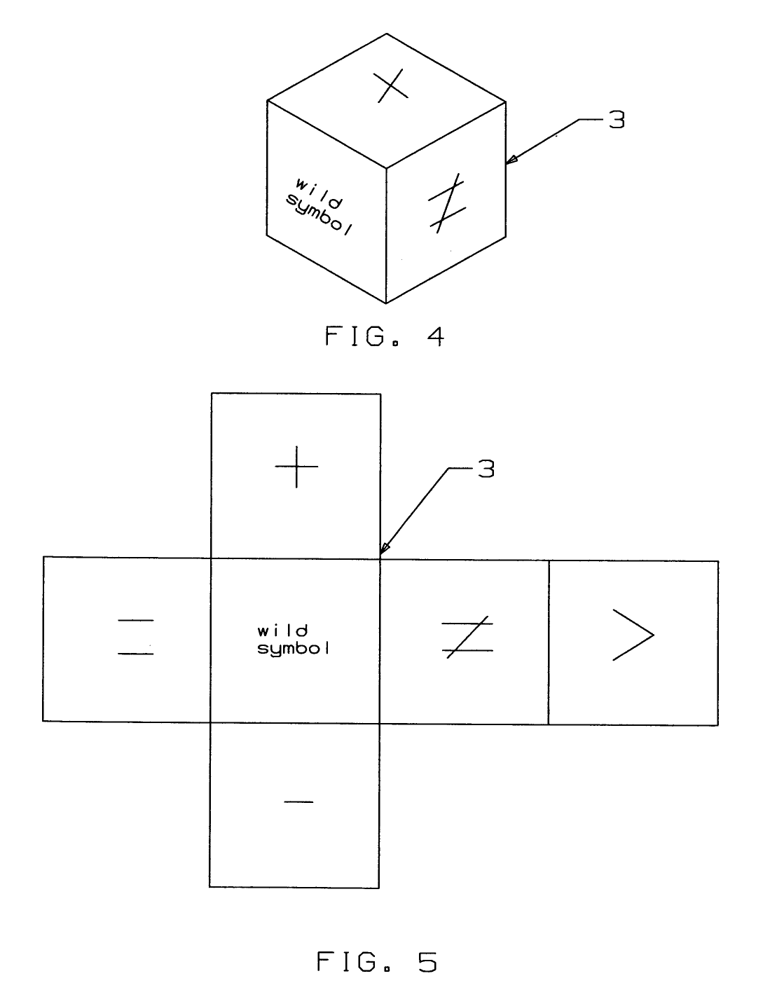

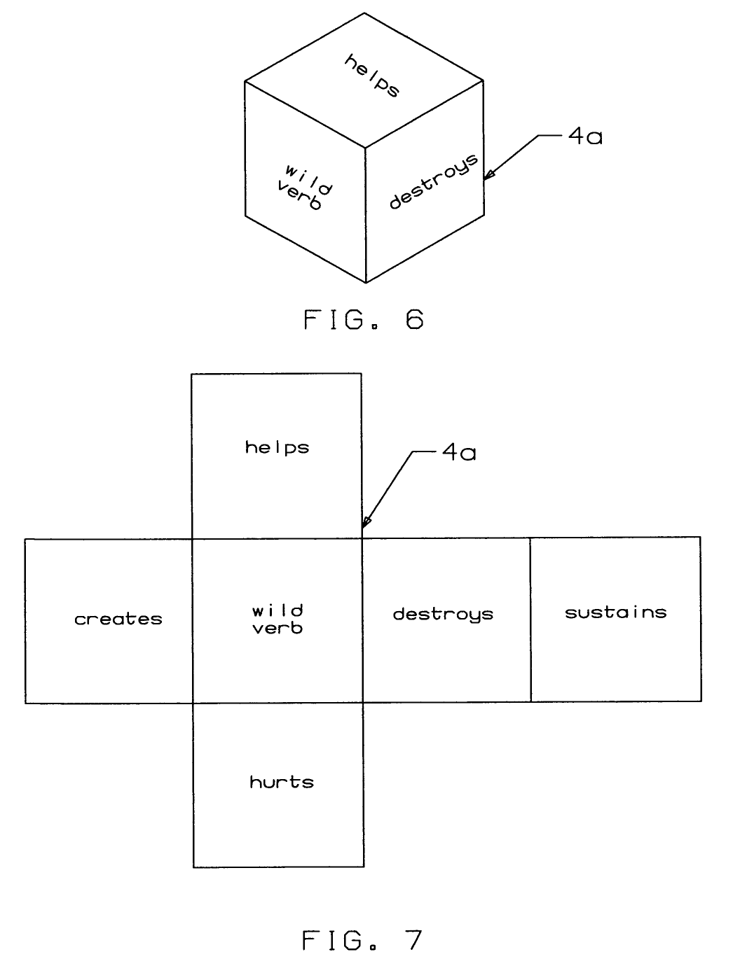

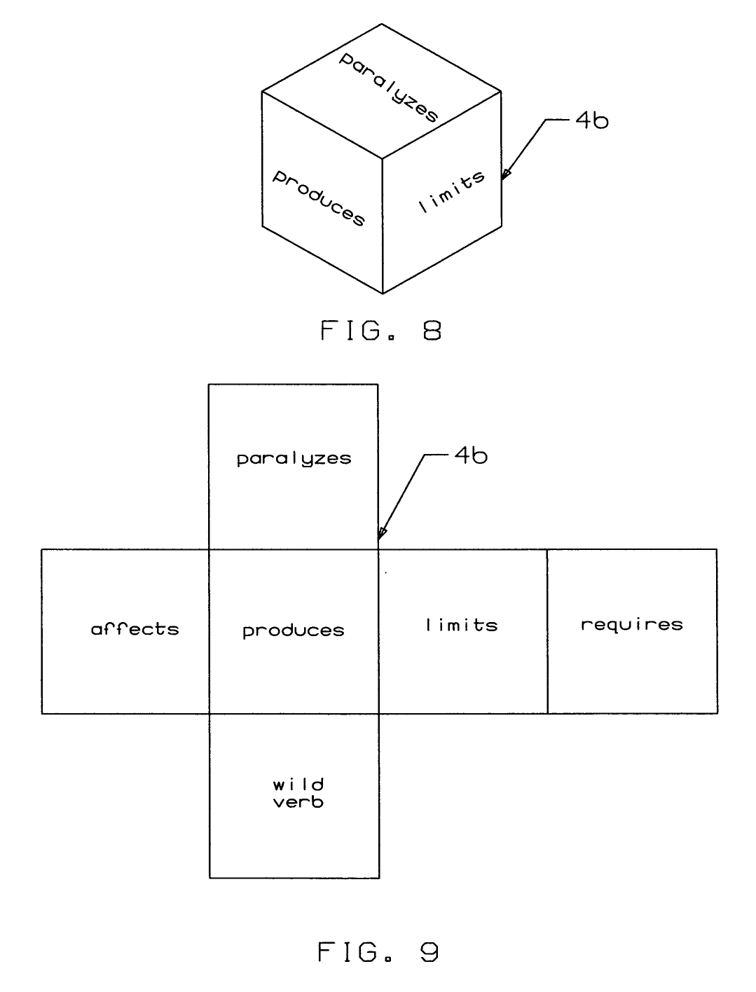

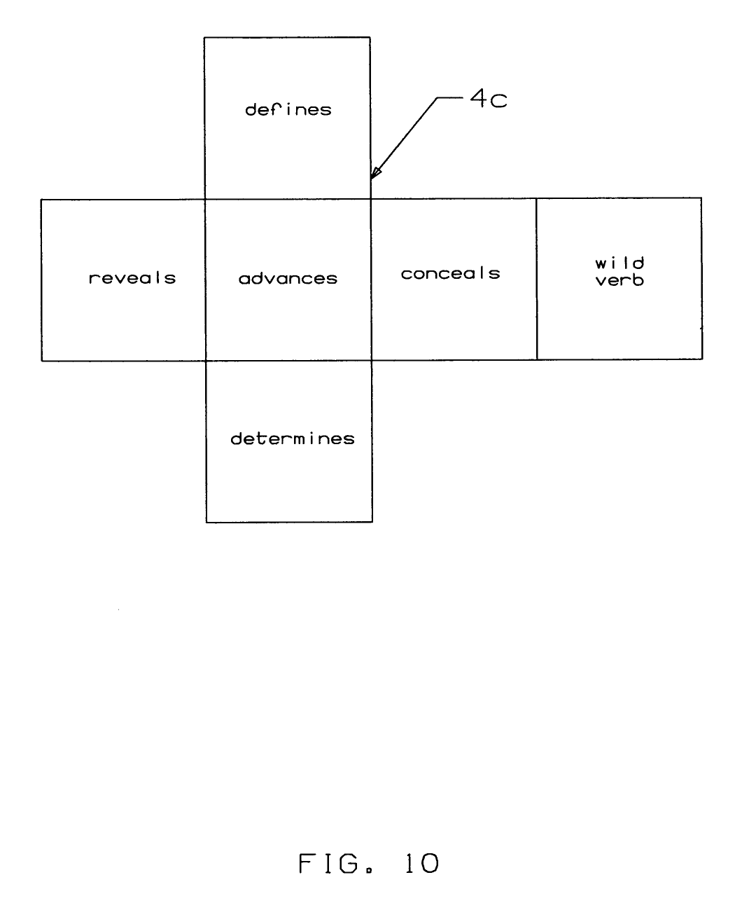

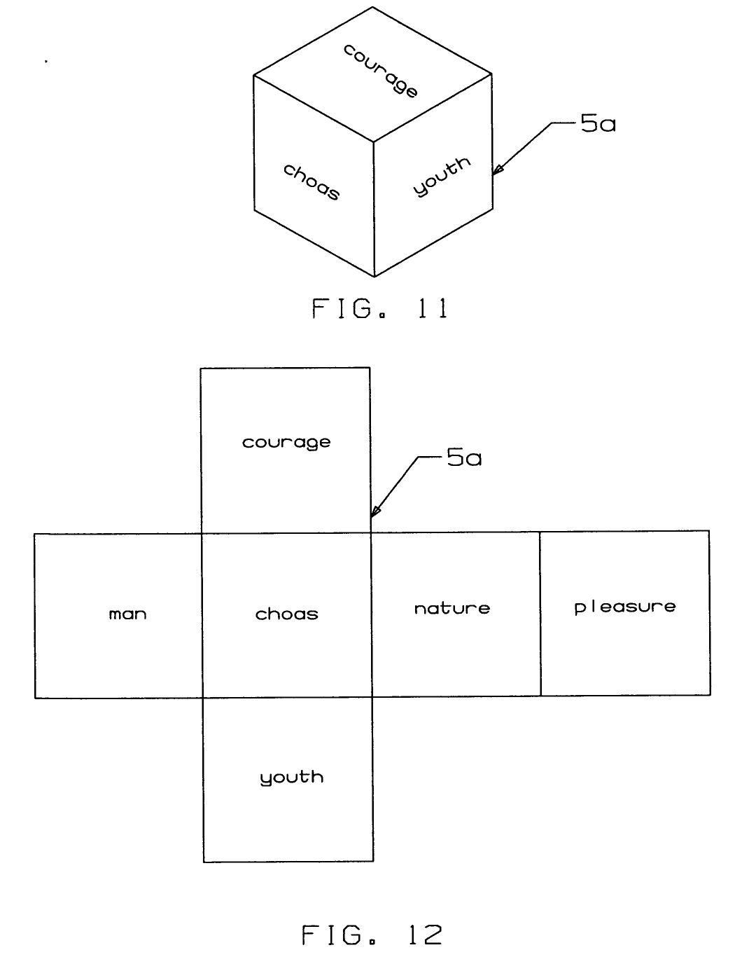

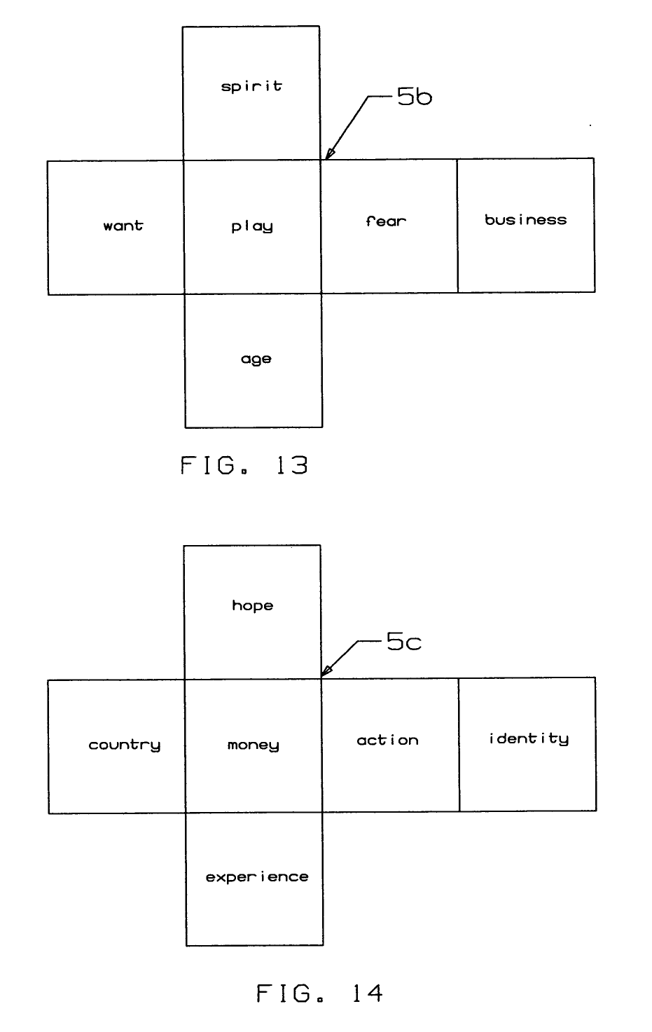

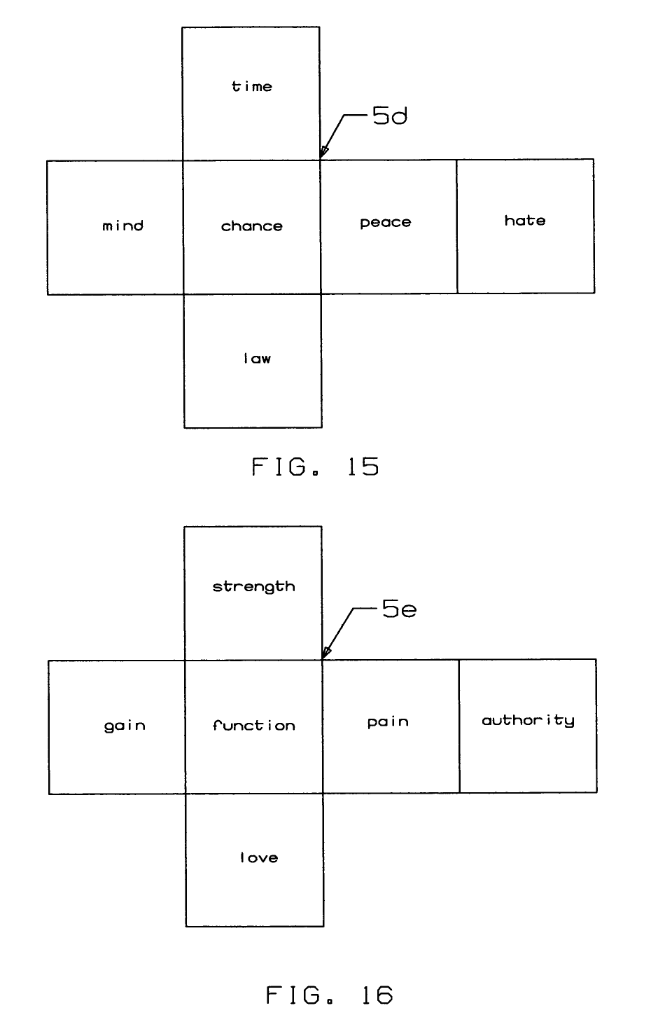

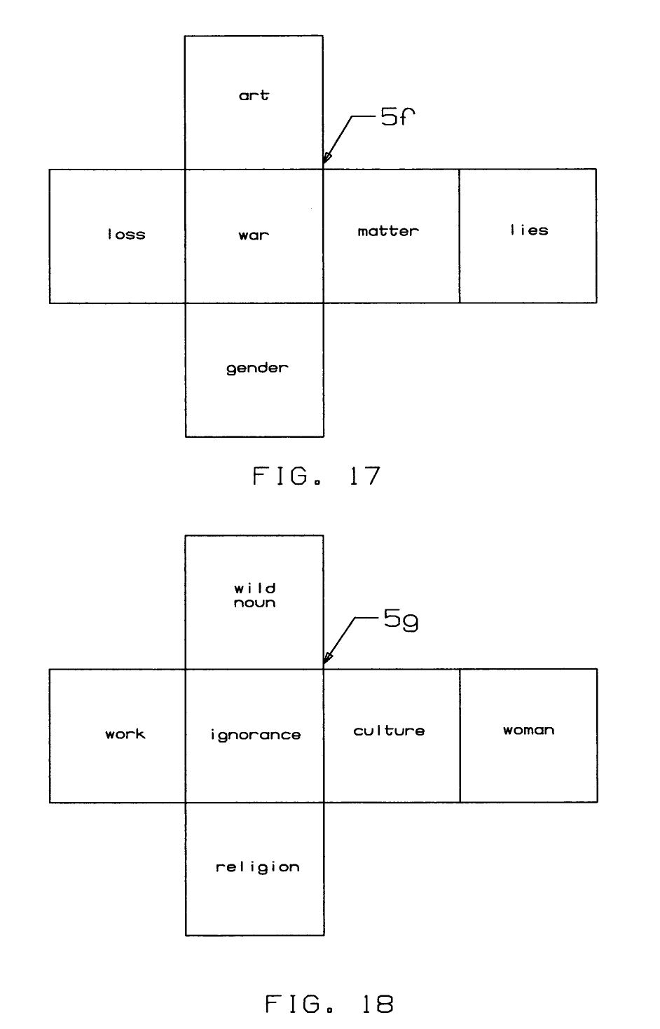

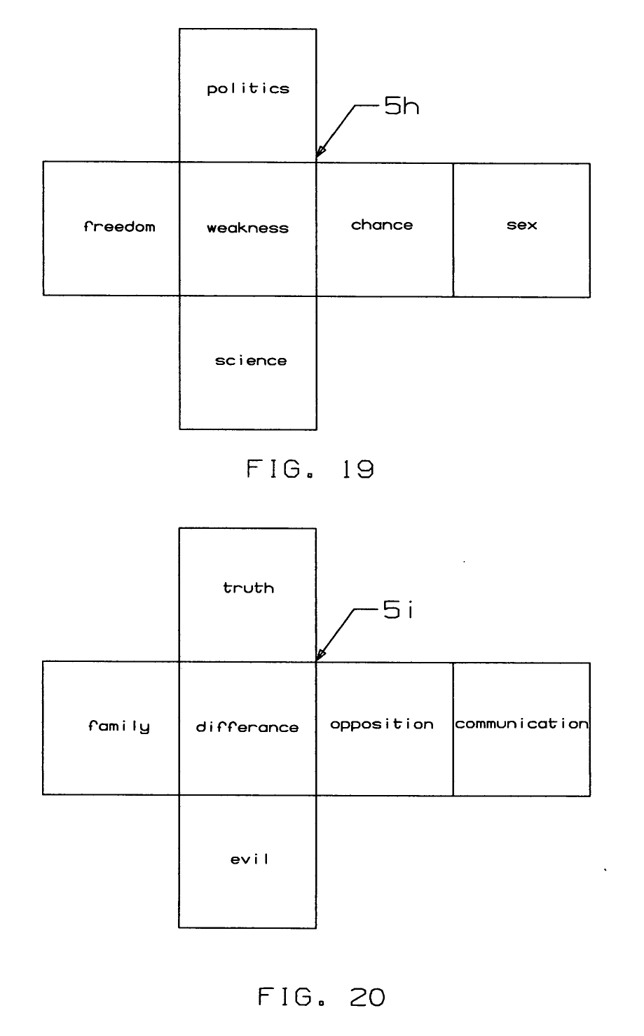

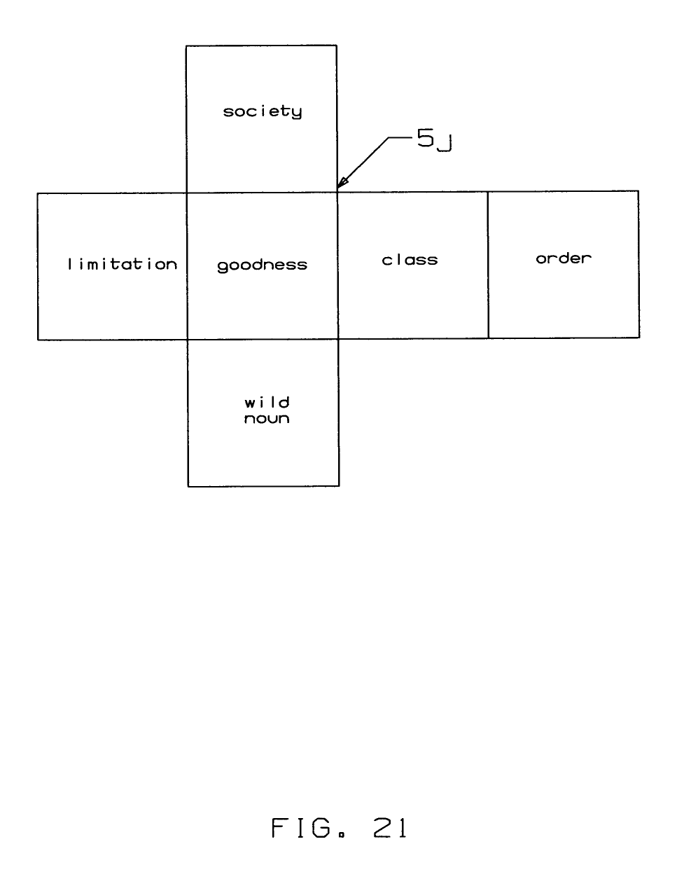

The game in either or all of the three: basic, intermediate or advanced formats typically consists of up to four predetermined rounds of play per format with each round involving the granting of an opportunity to each player to be an author in that round. After completion of all predetermined rounds of play in the basic format only, the player with the most points accumulated in all of the rounds is designated as the winner of the game. If, after all of the rounds in the basic format are played, it is the wish of the players to proceed to the intermediate format, then after four rounds thereof, the player with the most awarded points in all rounds is designated the winner. Correlatively, if it is decided to, after all such rounds to then proceed to the advanced format, then the player with the most points after the then twelve rounds of play is deemed to be the ultimate winner. There are up to ten non-equivalent noun blocks 5a through 5j to be noted with resort to FIGS. 11 through 21 inclusive respectively, two equivalent equation blocks 3 seen with resort to FIGS. 4 and 5, three non-equivalent verb blocks 4a, 4b and 4c to be noted with resort to FIGS. 6 through 10 inclusively, and one frequency block 2 noted with reference to FIGS. 2 and 3 available for use in the game depending upon the game format sought to be played and the rounds then being played therein. It should be noted, at this juncture, that it might be decided in advance by the players that less than four rounds per format might be played and/or that less than all three formats would be resorted to from commencement to completion of the

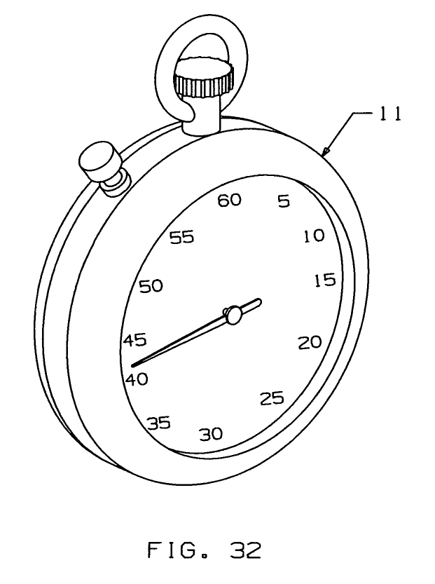

As regards the basic format, the following provisos apply. Tossing bag component 1 is, for round one thereof, filled with any seven of the ten noun blocks numbered 5a through 5j along with one of the verb blocks 4a, 4b or 4c. Each player, upon commencement of the game maybe optionally supplied with one of up to ten equivalent affirmative ballot cards 8 depicted in FIGS. 26 and 27 each with the word, ballot imprinted on the top side thereof and each with the word, yes imprinted on the bottom side thereof and with one of the ten equivalent negative ballot cards 7 as depicted in FIGS. 24 and 25 each with the word, ballot imprinted on the top side thereof and each with the word, yes imprinted on the bottom side thereof. These are laid face down by each player in front of him or her. A timing device such as the stopwatch 11 seen in FIG. 32 is likewise utilized by the players. Upon completion of round one and at the beginning of round two, two additional noun blocks among the remaining ones of blocks 5a through 5j and one additional verb block among the remaining two of blocks 4a, 4b and 4c are placed into tossing bag component 1 for use by the players. The third round is played by way of an adding of the two equivalent equation blocks 3 to be shaken within and then tossed out of tossing bag component 1 by each player in that round then acting as an author. The fourth round involves the adding of yet another noun block among the remaining ones of blocks 5a through 5j and yet another verb block, to wit, the remaining one of blocks 4a, 4b and 4c to be so shaken and tossed respectively by each player within that final round. Acceptance or rejection of an author's argument in support thereof, is reflected by either a majority voice vote or, a majority vote as reflected, by a turning over, by each of the opposing players, of either an optionally provided affirmative ballot card 8 from the top side to the bottom side thereof or an optionally provided negative ballot card 7 from the top side to the bottom side thereof, all upon completion of the argument by the author within the previously agreed-to time allotted for completion of the same.

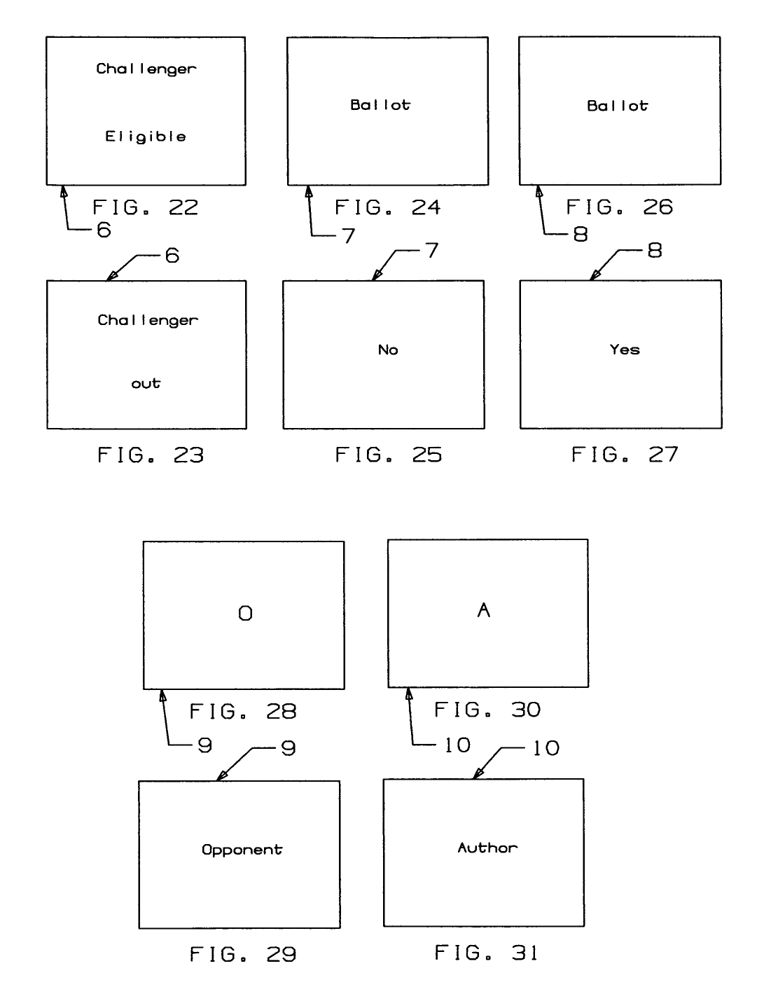

Within the framework of all three formats of the game, once again, any statement composed by an author after having spilled out blocks may be made up of words appearing on the face-up facets of either some or indeed all of the blocks. One point is awarded to the author after ultimate acceptance of the author's argument by a majority of the other players for each word in any three word statement, and two points per word are awarded for each word utilized in any four or more word statement as would have been deemed to have been successfully and timely argued for by an author in the minds eyes of a majority of the opposing players. But, once again, no would-be statement consisting of less than three words may be utilized as any predicate for a refining thereof and then subsequent argument regarding the same. Prepositions and definite or indefinite articles as noted previously may be utilized to refine a composed statement, but any such prepositions or articles so used are not countable for purposes of an author's being awarded points. Every refined statement must include at least one face up verb block 4a, 4b or 4c or a face up symbol from at least one equivalent equation block 3 when utilized during any tossing event. Each greater than and each less than symbol on each equivalent equation block 3 may be used in composing a statement either as “greater than” or “less than” after having been initially spilled out face up by an author-player. The equal and unequal signs found upon the facets of an equation block 3 can stand for, for example, “the same as” or “different than” respectively in the composition of a statement. The plus and negative signs thereupon can connote, for example, “together with” or “without” respectively. The “wild” facet if found face up after a roll can be utilized as being any one of the other five symbols on the block. The “wild” facets on noun block numbered 5g or 5j or verb block 4a, 4b or 4c can be utilized as being any one of the other five symbols on the block on which they are to be found in the event one or more of them are rolled face up upon completion of a toss. The intermediate format differs from the basic format insomuch as the intermediate format involves resort to the specialized utilization by each of the players of one of up to ten equivalent challenge cards 6 as depicted in FIGS. 22 and 23 with the word eligible imprinted on the top side of each and the word, out imprinted on the bottom side of each, as well as resort to now a debate format. One player is assigned the task of serving as a moderator of the debate. The protocols established in the basic format are endemic to this format as well, except that with respect to this format, once a non-author elects to become a challenger, to wit, challenging acceptor and issue a challenge to an argument in support of a refined statement as evidenced by that non-author's turning his or her challenger card 6 over from the “eligible” side as seen in FIG. 22 to the “out” side as seen in FIG. 23, all pursuant to an invitation extended by the moderator to do so with the moderator extending such invitations to each non-author to challenge or not by moving counter clockwise with invitations starting from the player to the right of the author, then that challenging acceptor, in respect of such specialized utilization may no longer thereafter issue a challenge for the balance of that round in that format. Moreover, once such a challenge accordingly issues, the debating ensues. The challenging acceptor provides an argument in opposition to the author's argument, not defended in this format, and the author is then given an opportunity to rebut such opposition. Such rebuttal is followed by the challenging acceptor's one minute closing argument followed by a vote by all players except the author as respects whether the author has prevailed so as to then be awarded points. A challenging acceptor may cede his or her opportunity to close upon request from another player to do so, but if such other player makes the closing, that player's right to challenge later in the round is forfeited. If there are no challengers left in the round to oppose an author's argument, then the author is automatically awarded points tabulated just as with respect to the tabulation protocol established as regards the basic format except as respects the matter of resort to, in this format, utilization of the frequency block 2 as depicted in FIGS. 2 and 3. The frequency block 2 is utilized in this format. Frequency block 2 has adverbs on five of the six facets thereof and the word, “wild” on one facet thereof. If the “wild” facet is tossed face up, then, use may be made of any adverb from any one of the other facets thereof for purpose of composing a statement within the aegis of this format. An author successfully arguing in support of a statement predicated upon resort to a face-up symbol on a frequency block is awarded an additional five points for the argument. If on the other hand, subsequent to a challenge and debate as noted above, the author does not secure a majority of votes in his or her favor, then, the challenging acceptor is awarded the five points only. This is the only instance within the framework of the format wherein a challenging acceptor might acquire points if an author fails to acquire any for lack of a majority vote in his or her favor following the end of debate during that author's turn.

The advanced format incorporates all of the features of the intermediate format. However, in this format, optional opponent ballot cards 9 as depicted in FIGS. 28 and 29 and optional author ballot cards 10 as depicted in FIGS. 30 and 31 are utilized. These cards are utilized for the purpose of tallying votes at the end of a debate. In the advanced format, if the author does not prevail by a majority, per a vote tally wherein neither the author nor the challenging acceptor may vote, then, the challenging acceptor is awarded all of the points that would have otherwise been awarded to the author. Moreover, in this format, there is no opportunity afforded to any second would-be challenging acceptor to make a closing argument for a first challenger. In this format, a turning over of an opponent ballot card 9, a topside of which is shown in FIG. 28 so as to show the bottomside of that card as shown in FIG. 29 signifies a player's post-debate vote for a challenger and conversely, a turning over instead of an author ballot card 10, the topside of which is seen in FIG. 30 so as to thereby show the bottomside of that card as seen in FIG. 31 signifies a player's post-debate vote for the author.

The game can be played with up to four rounds of play as specified above in either the basic or intermediate or advanced formats of play. Alternative, it could be played with up to four rounds of play as specified above per format in first the basic format and then the intermediate or advanced format. Or, it could be played for up to four rounds of play as specified above per format in only the intermediate and then advanced format. Or finally it could be played for up to four rounds of play as specified above per format for all three formats of play.

In conclusion, it is respectfully submitted that the instant game of defending statements with persuasive arguments is not only new but indeed useful from the vantage point of providing a source of true relaxation to people within a group setting. Finally, as well, it is likewise truly unique as a means for promoting intellectual stimulation as well as being truly a viable resource for facilitating on-the-spot learning.

What is claimed is:

1. A game of defending statements with persuasive arguments, comprising the steps of:
a. filling a tossing bag with any seven of ten non-equivalent noun blocks with each of said ten noun blocks having a noun word imprinted on each facet of each said noun block save for one facet of each of two of said noun blocks having no word imprinted thereon and being each a wild noun facet in respect of which any other noun word imprinted upon said each of said two of said noun blocks can be deemed thereupon designated together with any one of three non-equivalent verb blocks with each of said three verb blocks having a verb word imprinted on each facet of each said verb block save for one facet of one of said verb blocks having no word imprinted thereon and being a wild verb facet in respect of which any other verb word on said one of said verb blocks can be designated;
b. having one of a plurality of players of said game, said one being designated as an author, toss said noun blocks and said one of said verb blocks from said bag onto a firm flat surface;
c. having said author compose a statement from words appearing on at least three upwardly lying facets of said verb block and said noun blocks and requiring at least one of said words of said statement to be a verb and further permitting resort to pluralization and use of prepositions, definite articles and indefinite articles in respect of said composing of said statement;
d. having said author then refine said statement in a form of proposition being a complete sentence;
e. having said author articulate a supportive argument in defense of said statement so refined;
f having said author defend said argument should said argument be challenged by any other one of said plurality of players of said game;
g. providing a set period of time for said author to compose, refine, argue and defend as aforesaid with said period of time clocked by means of a stopwatch;
h. having all said other ones of said plurality of players of said game by majority vote accept or reject said argument;
i. awarding points to said author only if said argument is so accepted, to wit, one point for each of a first three words and two points for each of all words in excess of three contained within said composed statement;
j. designating another one of said plurality of players of said game to serve as an author;
k. repeating steps a. through i. inclusive above in respect of said another one's then participation in said game;
l. repeating steps j. and k. inclusive above until all of said plurality of players of said game will have been designated as and will have accordingly served as an author in completion of a first round of a basic format of said game;
m. declaring a one round basic format game winner, if completion of said round is to constitute completion of said game, to be a one of said plurality of players of said game having then accumulated a largest number of said points;
n. optionally initiating a second round of said basic format by placing two more of said ten non-equivalent noun blocks and one more of said three non-equivalent verb blocks into said tossing bag;
o. repeating step 1. abovesaid until all of said plurality of players of said game will have completed said second round of said basic format of said game;
p. declaring a two round basic format game winner, if completion of said first round and second round is to constitute completion of said game, to be a one of said plurality of players of said game having then accumulated a largest number of said points;
q. optionally initiating a third round of said basic format by placing two equivalent equation blocks with each said equation block having imprinted upon each facet thereof respectively, one of the following symbols per said each facet, to wit: a “greater or less than” sign, a plus sign, a minus sign, an equals sign, an unequals sign; and a word, “wild” and further providing that said each facet having thereupon imprinted said word, “wild” as being meant to serve as being equatable with any other one of said symbols;
r. repeating step 1. abovesaid until all of said plurality of players of said game will have completed said third round of said basic format of said game;
s. declaring a three round basic format game winner, if completion of said first round, said second round and said third round is to constitute completion of said game, to be a one of said plurality of players of said game having then accumulated a largest number of said points;
t. optionally initiating a fourth round of said basic format by placing a last one of said ten non-equivalent noun blocks and a last one of said three non-equivalent verb blocks into said tossing bag;
u. repeating step 1. abovesaid until all of said other players of said game will have completed said fourth round of said basic format of said game, and;
v. declaring a four round basic format game winner to be a one of said plurality of players having then accumulated a largest number of said points.

2. The game of defending statements with persuasive arguments of claim 1, whereby each said majority vote by said all said other ones of said plurality of players of said game is signified quantitatively with resort to utilization by each of said all of said other ones of one of a plurality of affirmative ballot cards or one of a plurality of negative ballot cards as each of said all of said other ones turns over from a blank top side either said each's said one of said plurality of affirmative ballot cards or said one of said plurality of negative ballot cards to show for an individual vote an affirmative designation on a bottom side of each said one of said plurality of affirmative ballot cards or a negative designation on a bottom side of each said one of said plurality of negative ballot cards.

3. The game of defending statements with persuasive arguments of claim 1, whereby said composition of said statement, during said round three and said round four of said game played in said basic format, requires use of at least one of said verb words or at least one of said equation block signs.

4. A game of defending statements with persuasive arguments, comprising the steps of:
a. having one of a plurality of players of the game appointed as a debate moderator.
b. filling a tossing bag with any seven of ten non-equivalent noun blocks with each of said ten noun blocks having a noun word imprinted on each facet of each said noun block save for one facet of each of two of said noun blocks having no word imprinted thereon and being each a wild noun facet in respect of which any other noun word imprinted upon said each of two of said noun blocks can be deemed thereupon designated together with any one of three non-equivalent verb blocks with each of said three verb blocks having a verb word imprinted on each facet of each said verb block save for one facet of one of said verb blocks having no word imprinted thereon and being a wild verb facet in respect of which any other verb word on said one of said verb blocks can be designated;
c. having one of said plurality of players of the game, said one being designated as an author, toss said noun blocks and said one of said verb blocks together with a frequency block having an adverb word imprinted on each of five facets thereof and the word, “wild” imprinted on one facet thereof all from said bag onto a firm flat surface;
d. having said author compose a statement from words appearing on at least three upwardly lying facets of said verb block and said noun blocks and requiring at least one of said words of said statement to be a verb and further permitting resort to pluralization and use of prepositions, definite articles and indefinite articles in respect of said composing of said statement;
e. having said author then refine said statement in a form of proposition being a complete sentence;
f. having said author articulate a supportive argument in defense of said statement so refined;
g. having said author prepared to confront a challenge should said argument be challenged by any other one of said plurality of players of said game as evidenced by a turning over by said any other one of said any other one's single one of a plurality of equivalent challenge cards assigned to each said any other one of said plurality of players of said game;
h. said turning over being evidenced by a rotating of said single one from an initially top side marked with a word, “eligible”, face up position to a bottom side marked with a word, “out” then face up;
i. said turning over being engaged in at the option of a first one of said any other one upon invitation extended by said moderator;
j. with declining of said invitation by said first one prompting said moderator's extension of a next invitation to another of said any other one of said plurality of players of said game not then designated as an author;
k. with ultimate acceptance of said invitation or after any said declining of said invitation, then acceptance of said next invitation resulting in an offer by an ultimate acceptor of said, said next invitation of a counter-argument in opposition to said argument;
l. having said author offer a rebuttal argument;
m. having said acceptor offer a closing argument or cede an opportunity to make said closing argument to another of said any other players to then assume the role of said acceptor;
n. providing set periods of time for completion of said argument, then said counter-argument, the said rebuttal argument, then said closing argument with said set periods of time clocked by means of a stopwatch;
o. having all said other ones of said plurality of players of said game excepting said acceptor by majority vote to accept or reject said argument;
p. awarding points to said author only if said argument is so accepted, to wit, one point for each of a first three words and two points for each of all words in excess of three contained within said composed statement, or if said argument is not so accepted, then awarding five points to said acceptor but only if said rebuttal argument is predicated in part upon resort to utilization of said frequency blocks;
q. designating another one of said plurality of players of said game to serve as an author;
r. repeating steps b., through q., inclusive abovesaid in respect of said another one's then participation in said game;
s. repeating steps b., through r., inclusive abovesaid until all of said plurality of players of said game will have been designated as and will have accordingly served as an author in completion of a first round of an intermediate format of said game;
t. declaring a one round intermediate format game winner, if completion of said round is to constitute completion of said game, to be a one of said plurality of players of said game having then accumulated a largest number of said points;
u. optionally initiating a second round of said intermediate format by placing two more of said ten non-equivalent noun blocks and one more of said three non-equivalent verb blocks into said tossing bag;
v. repeating step s. abovesaid until all of said plurality of players of said game will have completed said second round of said intermediate format of said game;
w. declaring a two round intermediate format game winner, if completion of said first round and second round is to constitute completion of said game, to be a one of said plurality of players of said game having then accumulated a largest number of said points;
x. optionally initiating a third round of said intermediate format by placing two equivalent equation blocks with each said equation block having imprinted upon each facet thereof respectively, one of the following symbols per said each facet, to wit: a “greater or less than” sign, a plus sign, a minus sign, an equals sign, an unequals sign; and a word, “wild” and further providing that said each facet having thereupon imprinted said word, “wild” being meant to serve as being equatable with any other one of said symbols;
y. repeating step s. abovesaid until all of said plurality of players of said game will have completed said third round of said intermediate format of said game;
z. declaring a three round intermediate format game winner, if completion of said first round, said second round and said third round is to constitute completion of said game, to be a one of said plurality of players of said game having then accumulated a largest number of said points;
aa. optionally initiating a fourth round of said intermediate format by placing a last one of said ten non-equivalent noun blocks and a last one of said three non-equivalent verb blocks into said tossing bag;
bb. repeating step s. abovesaid until all of said other players of said game will have completed said fourth round of said intermediate format of said game, and;
cc. declaring a four round intermediate format game winner to be a one of said plurality of players having then accumulated a largest number of said points.

5. The game of defending statements with persuasive arguments of claim 4, whereby each said majority vote by said all said other ones of said plurality of players of said game is signified quantitatively with resort to utilization by each of said all of said other ones of one of a plurality of affirmative ballot cards or one of a plurality of negative ballot cards as each of said all of said other ones turns over from a blank top side either said each's said one of said plurality of affirmative ballot cards or said one of said plurality of negative ballot cards to show for an individual vote an affirmative designation on a bottom side of each said one of said plurality of affirmative ballot cards or a negative designation on a bottom side of each said one of said plurality of negative ballot cards.

6. The game of defending statements with persuasive arguments of claim 4, whereby composition of said statement, during said round three and said round four of said game played in said intermediate format, requires use of at least one of said verb words or at least one of said equation block signs.

7. A game of defending statements with persuasive arguments, comprising the steps of:
a. having one of a plurality of players of the game appointed as a debate moderator;
b. filling a tossing bag with any seven of ten non-equivalent noun blocks with each of said ten noun blocks having a noun word imprinted on each facet of each said noun block save for one facet of each of two of said noun blocks having no word imprinted thereon and being each a wild noun facet in respect of which any other noun word imprinted upon said each of two of said noun blocks can be deemed thereupon designated together with any one of three non-equivalent verb blocks with each of said three verb blocks having a verb word imprinted on each facet of each said verb block save for one facet of one of said verb blocks having no word imprinted thereon and being a wild verb facet in respect of which any other verb word on said one of said verb blocks can be designated;
c. having one of said plurality of players of the game, said one being designated as an author, toss said noun blocks and said one of said verb blocks together with a frequency block having an adverb word imprinted on each of five facets thereof and the word, “wild” imprinted on one facet thereof all from said bag onto a firm flat surface;
d. having said author compose a statement from words appearing on at least three upwardly lying facets of said verb block and said noun blocks and requiring at least one of said words of said statement to be a verb and further permitting resort to pluralization and use of prepositions, definite articles and indefinite articles in respect of said composing of said statement;
e. having said author then refine said statement in a form of proposition being a complete sentence;
f. having said author articulate a supportive argument in defense of said statement so refined;
g. having said author prepared to confront a challenge should said argument be challenged by any other one of said plurality of players of said game as evidenced by a turning over by said any other one of said any other one's single one of a plurality of equivalent challenge cards assigned to each said any other one of said plurality of players of said game;
h. said turning over being evidenced by a rotating of said single one from an initially top side marked with a word, “eligible”, face up position to a bottom side marked with a word, “out” then face up;
i. said turning over being engaged in at the option of a first one of said any other one upon invitation extended by said moderator;
j. with declining of said invitation by said first one prompting said moderator's extension of a next invitation to another of said any other one of said plurality of players of said game not then designated as an author;
k. with ultimate acceptance of said invitation or after any said declining of said invitation, then acceptance of said next invitation resulting in an offer by an ultimate acceptor of said, said next invitation of a counter-argument in opposition to said argument;
l. having said author offer a rebuttal argument;
m. having said acceptor offer a closing argument or cede an opportunity to make said closing argument to another of said any other players to then assume the role of said acceptor;
n. providing set periods of time for completion of said argument, then said counter-argument, the said rebuttal argument, then said closing argument with said set periods of time clocked by means of a stopwatch;
o. having all said other ones of said plurality of players of said game excepting said acceptor by majority vote to accept or reject said argument;
p. awarding points to said author only if said argument is so accepted, to wit, one point for each of a first three words and two points for each of all words in excess of three contained within said composed statement, or if said argument is not so accepted, then awarding five points to said acceptor but only if said rebuttal argument is predicated in part upon resort to utilization of said frequency blocks, and further also awarding to said acceptor all points as would have been awarded to said author had said argument been so accepted;
q. designating another one of said plurality of players of said game to serve as an author;
r. repeating steps b., through q., inclusive abovesaid in respect of said another one's then participation in said game;
s. repeating steps b., through r., inclusive abovesaid until all of said plurality of players of said game will have been designated as and will have accordingly served as an author in completion of a first round of an advanced format of said game;
t. declaring a one round advanced format game winner, if completion of said round is to constitute completion of said game, to be a one of said plurality of players of said game having then accumulated a largest number of said points;
u. optionally initiating a second round of said advanced format by placing two more of said ten non-equivalent noun blocks and one more of said three non-equivalent verb blocks into said tossing bag;
v. repeating step s. abovesaid until all of said plurality of players of said game will have completed said second round of said advanced format of said game;
w. declaring a two round advanced format game winner, if completion of said first round and second round is to constitute completion of said game, to be a one of said plurality of players of said game having then accumulated a largest number of said points;
x. optionally initiating a third round of said advanced format by placing two equivalent equation blocks with each said equation block having imprinted upon each facet thereof respectively, one of the following symbols per said each facet, to wit: a “greater or less than” sign, a plus sign, a minus sign, an equals sign, an unequals sign; and a word, “wild” and further providing that said each facet having thereupon imprinted said word, “wild” being meant to serve as being equatable with any other one of said symbols;
y. repeating step s. abovesaid until all of said plurality of players of said game will have completed said third round of said basic format of said game;
z. declaring a three round advanced format game winner, if completion of said first round, said second round and said third round is to constitute completion of said game, to be a one of said plurality of players of said game having then accumulated a largest number of said points;
aa. optionally initiating a fourth round of said advanced format by placing a last one of said ten non-equivalent noun blocks and a last one of said three non-equivalent verb blocks into said tossing bag;
bb. repeating step s. abovesaid until all of said other players of said game will have completed said fourth round of said basic format of said game, and;
cc. declaring a four round basic format game winner to be a one of said plurality of players having then accumulated a largest number of said points.

8. The game of defending statements with persuasive arguments of claim 7, whereby each said majority vote by said all said other ones of said plurality of players of said game is signified quantitatively with resort to utilization by each of said all of said other ones of one of a plurality of author ballot cards or one of a plurality of opponent ballot cards as each of said all of said other ones turns over from a blank top side either said each's said one of said plurality of author ballot cards or said one of said plurality of opponent ballot cards to show for an individual vote an author designation on a bottom side of each said one of said plurality of affirmative ballot cards or an opponent designation on a bottom side of each said one of said plurality of opponent ballot cards.

9. The game of defending statements with persuasive arguments of claim 7, whereby composition of said statement, during said round three and said round four of said game played in said advanced format, requires use of at least one of said verb words or at least one of said equation block signs.

10. A game of defending statements with persuasive arguments, comprising the steps of:
a. filling a tossing bag with any seven of ten non-equivalent noun blocks with each of said ten noun blocks having a noun word imprinted on each facet of each said noun block save for one facet of each of two of said noun blocks having no word imprinted thereon and being each a wild noun facet in respect of which any other noun word imprinted upon said each of said two of said noun blocks can be deemed thereupon designated together with any one of three non-equivalent verb blocks with each of said three verb blocks having a verb word imprinted on each facet of each said verb block save for one facet of one of said verb blocks having no word imprinted thereon and being a wild verb facet in respect of which any other verb word on said one of said verb blocks can be designated;
b. having one of a plurality of players of said game, said one being designated as an author, toss said noun blocks and said one of said verb blocks from said bag onto a firm flat surface;
c. having said author compose a statement from words appearing on at least three upwardly lying facets of said verb block and said noun blocks and requiring at least one of said words of said statement to be a verb and further permitting resort to pluralization and use of prepositions, definite articles and indefinite articles in respect of said composing of said statement;
d. having said author then refine said statement in a form of proposition being a complete sentence;
e. having said author articulate a supportive argument in defense of said statement so refined;
f. having said author defend said argument should said argument be challenged by any other one of said plurality of players of said game;
g. providing a set period of time for said author to compose, refine, argue and defend as aforesaid with said period of time clocked by means of a stopwatch;
h. having all said other ones of said plurality of players of said game by majority vote accept or reject said argument;
i. awarding points to said author only if said argument is so accepted, to wit, one point for each of a first three words and two points for each of all words in excess of three contained within said composed statement;
j. designating another one of said plurality of players of said game to serve as an author;
k. repeating steps a. through i. inclusive above in respect of said another one's then participation in said game;
l. repeating steps j. and k. inclusive above until all of said plurality of players of said game will have been designated as and will have accordingly served as an author in completion of a first round of a basic format of said game;
m. declaring a one round basic format game winner, if completion of said round is to constitute completion of said game, to be a one of said plurality of players of said game having then accumulated a largest number of said points;
n. optionally initiating a second round of said basic format by placing two more of said ten non-equivalent noun blocks and one more of said three non-equivalent verb blocks into said tossing bag;
o. repeating step 1. abovesaid until all of said plurality of players of said game will have completed said second round of said basic format of said game;
p. declaring a two round basic format game winner, if completion of said first round and second round is to constitute completion of said game, to be a one of said plurality of players of said game having then accumulated a largest number of said points;
q. optionally initiating a third round of said basic format by placing two equivalent equation blocks with each said equation block having imprinted upon each facet thereof respectively, one of the following symbols per said each facet, to wit: a “greater or less than” sign, a plus sign, a minus sign, an equals sign, an unequals sign; and a word, “wild” and further providing that said each facet having thereupon imprinted said word, “wild” as being meant to serve as being equatable with any other one of said symbols;
r. repeating step 1. abovesaid until all of said plurality of players of said game will have completed said third round of said basic format of said game;
s. declaring a three round basic format game winner, if completion of said first round, said second round and said third round is to constitute completion of said game, to be a one of said plurality of players of said game having then accumulated a largest number of said points;
t. optionally initiating a fourth round of said basic format by placing a last one of said ten non-equivalent noun blocks and a last one of said three non-equivalent verb blocks into said tossing bag;
u. repeating step 1. abovesaid until all of said other players of said game will have completed said fourth round of said basic format of said game, and;
v. declaring a four round basic format game winner to be a one of said plurality of players having then accumulated a largest number of said points;
w. having one of a plurality of players of the game appointed as a debate moderator;
x. filling a tossing bag with any seven of ten non-equivalent noun blocks with each of said ten noun blocks having a noun word imprinted on each facet of each said noun block save for one facet of each of two of said noun blocks having no word imprinted thereon and being each a wild noun facet in respect of which any other noun word imprinted upon said each of two of said noun blocks can be deemed thereupon designated together with any one of three non-equivalent verb blocks with each of said three verb blocks having a verb word imprinted on each facet of each said verb block save for one facet of one of said verb blocks having no word imprinted thereon and being a wild verb facet in respect of which any other verb word on said one of said verb blocks can be designated;
y. having one of said plurality of players of the game, said one being designated as an author, toss said noun blocks and said one of said verb blocks together with a frequency block having an adverb word imprinted on each of five facets thereof and the word, “wild” imprinted on one facet thereof all from said bag onto a firm flat surface;
z. having said author compose a statement from words appearing on at least three upwardly lying facets of said verb block and said noun blocks and requiring at least one of said words of said statement to be a verb and further permitting resort to pluralization and use of prepositions, definite articles and indefinite articles in respect of said composing of said statement;
aa. having said author then refine said statement in a form of proposition being a complete sentence;
bb. having said author articulate a supportive argument in defense of said statement
so refined;
cc. having said author prepared to confront a challenge should said argument be challenged by any other one of said plurality of players of said game as evidenced by a turning over by said any other one of said any other one's single one of a plurality of equivalent challenge cards assigned to each said any other one of said plurality of players of said game;
dd. said turning over being evidenced by a rotating of said single one from an initially top side marked with a word, “eligible”, face up position to a bottom side marked with a word, “out” then face up;
ee. said turning over being engaged in at the option of a first one of said any other one upon invitation extended by said moderator;
ff. with declining of said invitation by said first one prompting said moderator's extension of a next invitation to another of said any other one of said plurality of players of said game not then designated as an author;
gg. with ultimate acceptance of said invitation or after any said declining of said invitation, then acceptance of said next invitation resulting in an offer by an ultimate acceptor of said, said next invitation of a counter-argument in opposition to said argument;
hh. having said author offer a rebuttal argument;
ii. having said acceptor offer a closing argument or cede an opportunity to make said closing argument to another of said any other players to then assume the role of said acceptor;
jj. providing set periods of time for completion of said argument, then said counter-argument, the said rebuttal argument, then said closing argument with said set periods of time clocked by means of a stopwatch;
kk. having all said other ones of said plurality of players of said game excepting said acceptor by majority vote to accept or reject said argument;
ll. awarding points to said author only if said argument is so accepted, to wit, one point for each of a first three words and two points for each of all words in excess of three contained within said composed statement, or if said argument is not so accepted, then awarding five points to said acceptor but only if said rebuttal argument is predicated in part upon resort to utilization of said frequency blocks;
mm. designating another one of said plurality of players of said game to serve as an author;
nn. repeating steps b., through q., inclusive abovesaid in respect of said another one's then participation in said game;
oo. repeating steps b., through r., inclusive abovesaid until all of said plurality of players of said game will have been designated as and will have accordingly served as an author in completion of a first round of an intermediate format of said game;
pp. declaring a one round intermediate format game winner, if completion of said round is to constitute completion of said game, to be a one of said plurality of players of said game having then accumulated a largest number of said points;
qq. optionally initiating a second round of said intermediate format by placing two more of said ten non-equivalent noun blocks and one more of said three non-equivalent verb blocks into said tossing bag;
rr. repeating step s. abovesaid until all of said plurality of players of said game will have completed said second round of said intermediate format of said game;
ss. declaring a two round intermediate format game winner, if completion of said first round and second round is to constitute completion of said game, to be a one of said plurality of players of said game having then accumulated a largest number of said points;
tt. optionally initiating a third round of said intermediate format by placing two equivalent equation blocks with each said equation block having imprinted upon each facet thereof respectively, one of the following symbols per said each facet, to wit: a “greater or less than” sign, a plus sign, a minus sign, an equals sign, an unequals sign; and a word, “wild” and further providing that said each facet having thereupon imprinted said word, “wild” being meant to serve as being equatable with any other one of said symbols;
uu. repeating step s. abovesaid until all of said plurality of players of said game will have completed said third round of said basic format of said game;
vv. declaring a three round intermediate format game winner, if completion of said first round, said second round and said third round is to constitute completion of said game, to be a one of said plurality of players of said game having then accumulated a largest number of said points;
ww. optionally initiating a fourth round of said intermediate format by placing a last one of said ten non-equivalent noun blocks and a last one of said three non-equivalent verb blocks into said tossing bag;
xx. repeating step s. abovesaid until all of said other players of said game will have completed said fourth round of said intermediate format of said game, and;
yy. declaring a four round intermediate format game winner to be a one of said plurality of players having then accumulated a largest number of said points;
zz. having one of a plurality of players of the game appointed as a debate moderator.
aaa. filling a tossing bag with any seven of ten non-equivalent noun blocks with each of said ten noun blocks having a noun word imprinted on each facet of each said noun block save for one facet of each of two of said noun blocks having no word imprinted thereon and being each a wild noun facet in respect of which any other noun word imprinted upon said each of two of said noun blocks can be deemed thereupon designated together with any one of three non-equivalent verb blocks with each of said three verb blocks having a verb word imprinted on each facet of each said verb block save for one facet of one of said verb blocks having no word imprinted thereon and being a wild verb facet in respect of which any other verb word on said one of said verb blocks can be designated;
bbb. having one of said plurality of players of the game, said one being designated as an author, toss said noun blocks and said one of said verb blocks together with a frequency block having an adverb word imprinted on each of five facets thereof and the word, “wild” imprinted on one facet thereof all from said bag onto a firm flat surface;
ccc. having said author compose a statement from words appearing on at least three upwardly lying facets of said verb block and said noun blocks and requiring at least one of said words of said statement to be a verb and further permitting resort to pluralization and use of prepositions, definite articles and indefinite articles in respect of said composing of said statement;
ddd. having said author then refine said statement in a form of proposition being a complete sentence;
eee. having said author articulate a supportive argument in defense of said statement so refined;
fff. having said author prepared to confront a challenge should said argument be challenged by any other one of said plurality of players of said game as evidenced by a turning over by said any other one of said any other one's single one of a plurality of equivalent challenge cards assigned to each said any other one of said plurality of players of said game;
ggg. said turning over being evidenced by a rotating of said single one from an initially top side marked with a word, “eligible”, face up position to a bottom side marked with a word, “out” then face up;
hhh. said turning over being engaged in at the option of a first one of said any other one upon invitation extended by said moderator;
iii. with declining of said invitation by said first one prompting said moderator's extension of a next invitation to another of said any other one of said plurality of players of said game not then designated as an author;
jjj. with ultimate acceptance of said invitation or after any said declining of said invitation, then acceptance of said next invitation resulting in an offer by an ultimate acceptor of said, said next invitation of a counter-argument in opposition to said argument;
kkk. having said author offer a rebuttal argument;
lll. having said acceptor offer a closing argument or cede an opportunity to make said closing argument to another of said any other players to then assume the role of said acceptor;
mmm. providing set periods of time for completion of said argument, then said counter-argument, the said rebuttal argument, then said closing argument with said set periods of time clocked by means of a stopwatch;
nnn. having all said other ones of said plurality of players of said game excepting said acceptor by majority vote to accept or reject said argument;
ooo. awarding points to said author only if said argument is so accepted, to wit, one point for each of a first three words and two points for each of all words in excess of three contained within said composed statement, or if said argument is not so accepted, then awarding five points to said acceptor but only if said rebuttal argument is predicated in part upon resort to utilization of said frequency blocks, and further also awarding to said acceptor all points as would have been awarded to said author had said argument been so accepted;
ppp. designating another one of said plurality of players of said game to serve as an author;
qqq. repeating steps b., through q., inclusive abovesaid in respect of said another one's then participation in said game;
rrr. repeating steps b., through r., inclusive abovesaid until all of said plurality of players of said game will have been designated as and will have accordingly served as an author in completion of a first round of an intermediate format of said game;
sss. declaring a one round advanced format game winner, if completion of said round is to constitute completion of said game, to be a one of said plurality of players of said game having then accumulated a largest number of said points;
ttt. optionally initiating a second round of said advanced format by placing two more of said ten non-equivalent noun blocks and one more of said three non-equivalent verb blocks into said tossing bag;
uuu. repeating step s. abovesaid until all of said plurality of players of said game will have completed said second round of said advanced format of said game;
vvv. declaring a two round advanced format game winner, if completion of said first round and second round is to constitute completion of said game, to be a one of said plurality of players of said game having then accumulated a largest number of said points;
www. optionally initiating a third round of said advanced format by placing two equivalent equation blocks with each said equation block having imprinted upon each facet thereof respectively, one of the following symbols per said each facet, to wit: a “greater or less than” sign, a plus sign, a minus sign, an equals sign, an unequals sign; and a word, “wild” and further providing that said each facet having thereupon imprinted said word, “wild” being meant to serve as being equatable with any other one of said symbols;
xxx. repeating step s. abovesaid until all of said plurality of players of said game will have completed said third round of said basic format of said game;
yyy. declaring a three round advanced format game winner, if completion of said first round, said second round and said third round is to constitute completion of said game, to be a one of said plurality of players of said game having then accumulated a largest number of said points;
zzz. optionally initiating a fourth round of said advanced format by placing a last one of said ten non-equivalent noun blocks and a last one of said three non-equivalent verb blocks into said tossing bag;
aaaa. repeating step s. abovesaid until all of said other players of said game will have completed said fourth round of said advanced format of said game, and;
bbbb. declaring a four round advanced format game winner to be a one of said plurality of players having then accumulated a largest number of said points.

11. The game of defending statements with persuasive arguments of claim 10, whereby each said majority vote during a course of said basic, said intermediate and said advanced formats by said all said other ones of said plurality of players of said game is signified quantitatively with resort to utilization by each of said all of said other ones of one of a plurality of affirmative ballot cards or one of a plurality of negative ballot cards as each of said all of said other ones turns over from a blank top side either said each's said one of said plurality of affirmative ballot cards or said one of said plurality of negative ballot cards to show for an individual vote an affirmative designation on a bottom side of each said one of said plurality of affirmative ballot cards or a negative designation on a bottom side of each said one of said plurality of negative ballot cards, during a course of said advanced format having each said majority vote signified quantitatively with resort to utilization by each of said all of said other ones of a plurality of author ballot cards or one of a plurality of opponent ballot cards as each of said all of said other ones turns over from a blank top side either said each's said one of said plurality of author ballot cards or said each's said one of said plurality of opponent ballot cards to show for an individual vote, an author designation on a bottom side of each said one of said plurality of affirmative ballot cards or an opponent designation on a bottom side of each said one of said plurality of opponent ballot cards.

12. The game of defending statements with persuasive arguments of claim 10, whereby composition of said statement, during said round three and said round four of said game played in said basic, said intermediate and said advanced format, requires use of at least one of said verb words or at least one of said equation block signs.
